(19) United States
(12) Patent Application Publication
(10) Pub. No.: US 2010/0225313 A1
(43) Pub. Date: Sep. 9, 2010

(54) ATOMIC MAGNETOMETERS FOR USE IN THE OIL SERVICE INDUSTRY

(75) Inventor: Martin Blanz, Celle (DE)

Correspondence Address: CANTOR COLBURN LLP- BAKER HUGHES INCORPORATED, 20 Church Street, 22nd Floor, Hartford, CT, 06103, US

(73) Assignee: BAKER HUGHES INCORPORATED, Houston, TX (US)

(21) Appl. No.: 12/715,541

(22) Filed: Mar. 2, 2010

Related U.S. Application Data
(60) Provisional application No. 61/156,966, filed on Mar. 3, 2009.

(51) Int. Cl. G01V 3/00

(52) U.S. Cl. 324/303; 324/304

(57) ABSTRACT

An apparatus for obtaining information from a subterranean environment, the apparatus includes: an atomic magnetometer configured to measure a magnetic field related to the information. An associated method for obtaining the information is also disclosed.

### BACKGROUND OF THE INVENTION

1. Field of the Invention

The present invention relates to estimating a property of an earth formation. More particularly, the present invention relates to techniques for more accurately measuring signals from the earth formation that provide information about a property of the earth formation.

2. Description of the Related Art

Exploration and production of hydrocarbons or geothermal energy requires that accurate and precise measurements be performed on earth formations, which may contain reservoirs of the hydrocarbons or geothermal energy. Some of these measurements are performed at the surface of the earth and may be referred to as surveys. Other measurements are generally performed in boreholes penetrating the earth formations. The process of performing these measurements in boreholes is called “well logging.”

In one example of well logging, a logging tool, used to perform the measurements, is lowered into a borehole and supported by a wireline. The logging tool contains various components that perform the measurements and record or transmit data associated with the measurements.

Various types of measurements can be performed in a borehole. One type of measurement is known as a nuclear magnetic resonance (NMR) measurement. In conventional NMR logging, a strong magnet is used to polarize nuclei in the formation. A series of radio frequency (RF) pulses are then transmitted into the formation to tip the angular momentum of the nuclei. Between pulses, the nuclei precess and transmit signals, known as NMR signals. From the amplitude and decay of these signals, information can be gained about at least one property of the formation. The NMR signals are typically received with a receiver coil by inducing a voltage and/or current in the coil.

The frequency of the RF pulses can be varied to measure a property of the earth formation at various distances into the earth formation. Using too low a frequency, though, can result in weak NMR signals being induced in the receiver coil. The weak NMR signals can be noisy having a low signal to noise ratio. Noisy signals can be difficult to interpret and extract information related to the property under investigation because the noise can mask important information in the signal.

In another type of NMR measurement, known as one variant of earth's field NMR, the earth's magnetic field may be used to polarize the nuclei under investigation. The earth's magnetic field, though, is generally weak and the resulting NMR signals induced in the receiver coil can also be weak. As with low frequency NMR signals, earth's field NMR signals can be noisy and difficult to interpret.

Some types of surface surveys of earth formations require measuring a magnetic field. Because of the distance from the formation to surface survey equipment, especially if the survey equipment is airborne, the magnetic fields of interest may be very weak. As with weak NMR signals, conventional magnetometers may provide a noisy and difficult to interpret signals.

Therefore, what are needed are techniques for measuring weak electromagnetic signals and, in particular, weak magnetic fields for exploration of hydrocarbon-bearing earth formations or geothermal energy.

### BRIEF SUMMARY OF THE INVENTION

Disclosed is an apparatus for obtaining information from a subterranean environment, the apparatus includes: an atomic magnetometer configured to measure a magnetic field related to the information.

Also disclosed is a method for obtaining information from a subterranean environment, the method includes: conveying an atomic magnetometer to a location to obtain the information; and measuring a magnetic field using the atomic magnetometer wherein the magnetic field is related to the information.

### BRIEF DESCRIPTION OF THE DRAWINGS

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings, wherein like elements are numbered alike, in which:

FIG. 1 illustrates an exemplary embodiment of a logging tool disposed in a borehole penetrating an earth formation;

FIGS. 2A and 2B, collectively referred to as FIG. 2, depict aspects of an instrument and an atomic magnetometer disposed at the logging tool;

FIG. 3 illustrates an exemplary embodiment of a survey instrument and the atomic magnetometer disposed in an aircraft flying above an earth formation;

FIG. 4 depicts aspects of an atomic magnetometer;

FIG. 5 depicts aspects of using the atomic magnetometer for navigation of the logging tool;

FIG. 6 depicts aspects of using the atomic magnetometer for telemetry between the logging tool and the surface of the earth; and

FIG. 7 presents one example of a method for estimating a property of the earth formation using the atomic magnetometer.

### DETAILED DESCRIPTION OF THE INVENTION

Disclosed are embodiments of techniques for estimating a property of an earth formation. The techniques, which include apparatus and method, call for measuring a magnetic field related to the property using an atomic magnetometer. The atomic magnetometer is very sensitive and has sensitivity that is comparable or even exceeds low-temperature superconducting quantum interference devices (SQUID). The noise of the atomic magnetometer is down to one femtoTesla/sqrt(Hz) or less, thus, accounting for the high sensitivity. In one embodiment, the atomic magnetometer exhibited magnetic field sensitivity of 0.5 fT/√Hz.

In one embodiment, the atomic magnetometer works by measuring the precession of electron spins in a magnetic field in a spin-exchange-relaxation-free (SERF) regime. The electron spins are in an alkali-metal vapor such as cesium contained in a glass cell. An infrared laser illuminates the glass cell and a photodetector receives light that passes through the cell. When the alkalai-metal vapor is not exposed to a magnetic field, the laser light passes straight through the atoms of the alkali-metal vapor. When the alkalai-metal vapor is in the presence of a magnetic field, though, the alignment of the atoms of the alkalai-metal vapor changes. The changed alignment of the atoms allows the atoms to absorb an amount of light proportional to the strength of the magnetic field. The photodetector measures the change in the transmitted light and relates the change to the strength of the magnetic field. In other embodiments, the atomic magnetometer can operate outside of the SERF regime. In addition, in other embodiments, a measurement of polarization rotation of the transmitted light or a measurement of a modulation frequency of the transmitted light can be used to measure the strength of the magnetic field.

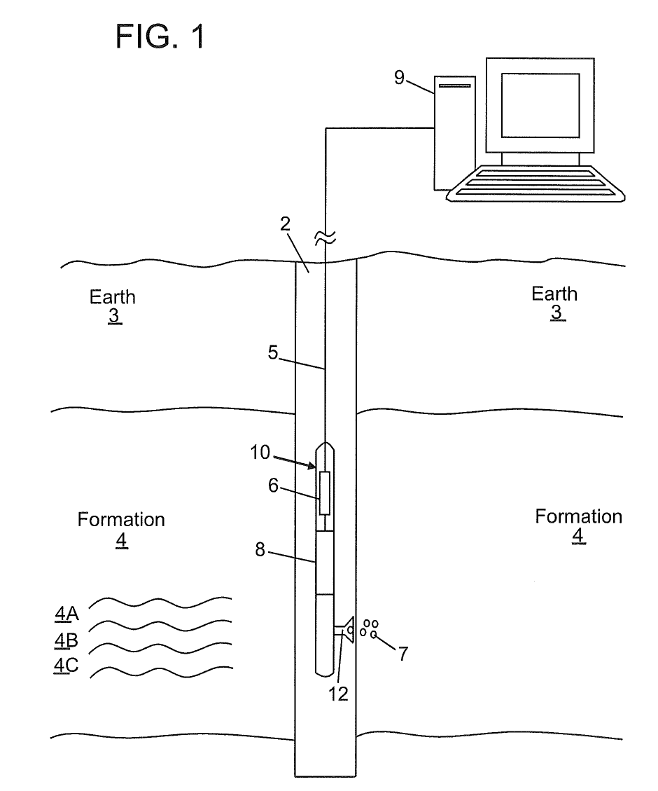

Reference may now be had to FIG. 1. FIG. 1 illustrates an exemplary embodiment of a logging tool 10 disposed in a borehole 2 penetrating the earth 3. Within the earth 3 is a formation 4 that includes formation layers 4A-4C. The logging tool 10 is conveyed through the borehole 2 by an armored wireline 5. In the embodiment of FIG. 1, the logging tool 10 includes an extraction device 12 configured to extract a fluid 7 from the formation 4. The logging tool 10 includes an instrument 6. The instrument 6 includes a component used to perform a measurement of a property of the formation 4 or the formation fluid 7. Coupled to the instrument 6 is an atomic magnetometer 8. The atomic magnetometer 8 is configured to detect and/or measure a magnetic field, which provides information to estimate the property of the formation 4 or of the formation fluid 7.

Referring to FIG. 1, the instrument 6 can also include electronic circuitry for processing, recording, or transmitting measurements performed by the instrument 6 in conjunction with the atomic magnetometer 8. The wireline 5 is one example of a component of a telemetry system used to communicate information, such as the measurements, to a processing system 9 at the surface of the earth 3. The processing system 9 is configured to receive data related to the measurements and to process the data to provide output to an operator or petroanalyst. The operator or petroanalyst can use the output on which to base drilling and completion decisions.

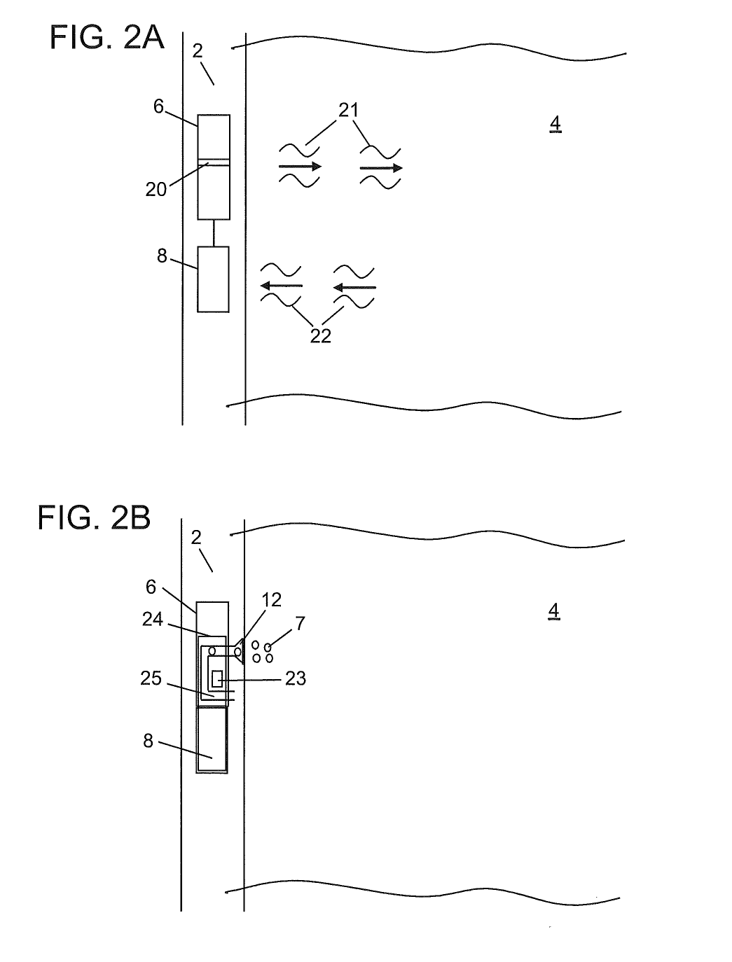

The instrument 6 can be configured to perform various types of measurements either individually or in combination. In one embodiment, the instrument 6 can be configured to perform earth's field nuclear magnetic resonance (NMR) measurements. For example, referring to FIG. 2A, the instrument 6 can include a transmitter coil 20 for transmitting a series of radio frequency (RF) pulses 21 into the formation 4. The RF pulses 21 tilt the angular momentum or spins of the nuclei in the formation 4 away from a relaxed state aligned with the earth's magnetic field. Between the RF pulses 21, the nuclei precess to the relaxed state and emit NMR signals 22. The NMR signals 22 are related to a property of the formation 4. Thus, measurements of the NMR signals 22 can be used to estimate the property of the formation 4. In accordance with the teachings herein, the atomic magnetometer 8 is used to receive and measure the NMR signals 22.

Another method of performing earth's field NMR is by polarizing the atomic nuclei in the formation 4 by applying a constant magnetic field for a time and then switching this field suddenly (i.e., non-adiabatically) off Once the field is switched off, the nuclear magnetization precesses around the earth's magnetic field and relaxes towards the equilibrium magnetization that is parallel to the earth's magnetic field. The lateral and longitudinal magnetization components may be detected by the atomic magnetometer 8 (see U.S. Pat. No. 4,987,368). The atomic magnetometer 8 can not only be used in earth's field NMR but in any NMR measurements where the Larmor frequency range is within a frequency range that can be measured by the atomic magnetometer 8 that is selected for the particular NMR measurements.

In another embodiment, the instrument 6 and the atomic magnetometer 8 are used to perform nuclear quadrupole resonance (NQR) measurements. NQR measurements are applicable to nuclei having an electric quadrupole moment. In NQR applications, the measurement frequency depends on the electric quadrupole moment of the nuclei and the electric field gradient at the position of these quadrupole nuclei. The atomic magnetometer 8 receives and measures the resulting NQR signals from the nuclei.

In the embodiment of FIG. 2B, the instrument 6 is configured to measure a property of the formation fluid 7. The formation fluid 7 is extracted from the formation 4 and channeled to the instrument 6 where NMR measurements are performed on the fluid 7. The instrument 6 in this embodiment includes components 23 configured to polarize and encode the fluid 7 prior to the fluid 7 emitting NMR signals 22. The instrument 6 can also include shields 24 to shield the instrument 6 from the earth's magnetic field. In one embodiment, Helmholtz coils can be used. The shields 24 would be active shields in this case. After being polarized and encoded (using audio frequency or radio frequency electromagnetic pulses), the fluid 7 enters a chamber 25 adjacent to the atomic magnetometer 8, which measures the NMR signals 22 emitted by the fluid 7. The NMR signals 22 are used to estimate a property of the formation fluid 7.

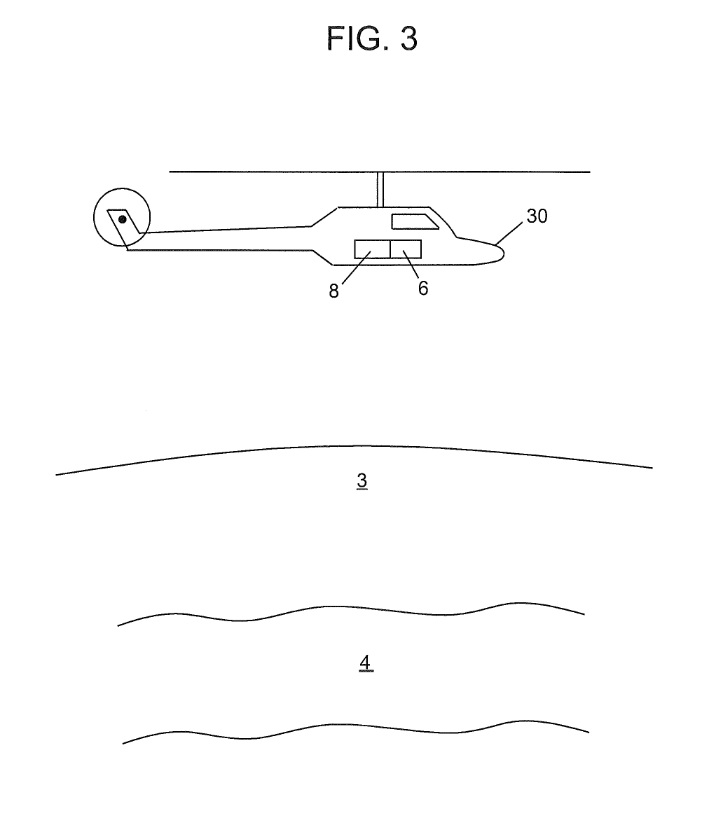

FIG. 3 illustrates an exemplary embodiment of the instrument 6 and the magnetometer 8 used for performing a survey of the formation 4 from above, such as from the surface of the earth 3 or in an aircraft. In the embodiment of FIG. 3, the instrument 6 and the atomic magnetometer 8 are disposed in an aircraft denoted as a carrier 30. Other non-limiting embodiments of the carrier 30 include a vehicle and a vessel. During performance of a survey, the atomic magnetometer 8 measures the magnetic field to which the atomic magnetometer 8 is exposed. The magnetic field is influenced by the formation 4 below. The instrument 6 can record the measurements performed by the atomic magnetometer 8 and associate each measurement with a location at which the measurement was performed. Thus, with the measurement and location data, a survey map of the formation 4 can be produced. In this case, the property of the formation 4 is the size and location of the formation 4. The survey map can also include any magnetic anomalies that were recorded. The magnetic anomalies can reflect changes in the composition of the formation 4.

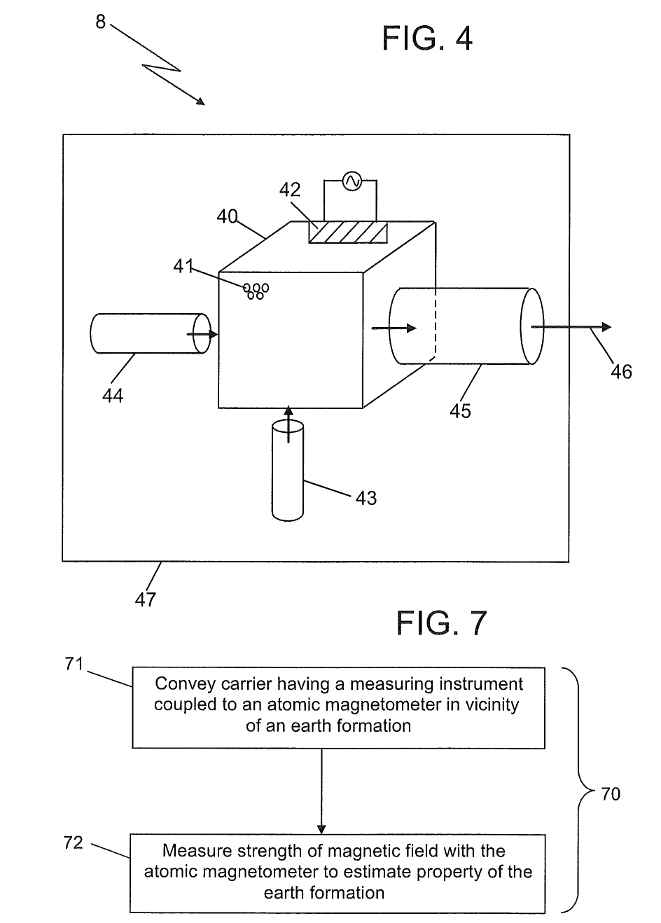

FIG. 4 depicts aspects of the atomic magnetometer 8. Referring to FIG. 4, the atomic magnetometer 8 includes a glass cell 40 filled with an alkalai-metal vapor 41. A heater 42 provides heat to the vapor 41 to keep the vapor 41 in a vapor state. In the embodiment of FIG. 4, the atomic magnetometer 8 includes an optical pumping laser 43 to spin-polarize the atoms of the vapor 41. Orthogonal to optical pumping laser 43 is a probe laser 44 for detecting/measuring precession of the nuclear spins of the atoms of the vapor 41 in the presence of a magnetic field. A photodetector 45 having at least one channel receives light from the probe laser 44 that passes through the glass cell 40 and vapor 41. The photodetector 45 provides an output signal 46 related to the amount of light the photodetector 45 measures. Thus, the output signal is correlated to the strength of the magnetic field measured by the atomic magnetometer 8. Surrounding at least the glass cell 40 is shielding 47 to shield the vapor 41 from external magnetic fields such as the earth's magnetic field. In one embodiment, the shielding 47 can be provided by Helmholtz coils that produce a counteracting magnetic field.

The atomic magnetometer 8 can be built in various ways. In one way, the atomic magnetometer 8 is assembled from a plurality of relatively large discrete components. In another way, the atomic magnetometer 8 is fabricated on at least one silicon substrate or chip using fabrication techniques used to fabricate semiconductor devices and circuitry. Such fabrication techniques include photolithography and micromachining In one embodiment, the atomic magnetometer 8 is built from at least one component that is a micro-electromechanical system (MEMS). In another embodiment, the entire atomic magnetometer 8 is built as a MEMS. One advantage of the atomic magnetometer 8 built on a chip is that many can be used to perform the same function with the outputs averaged to produce one output signal having a high signal-to-noise ratio.

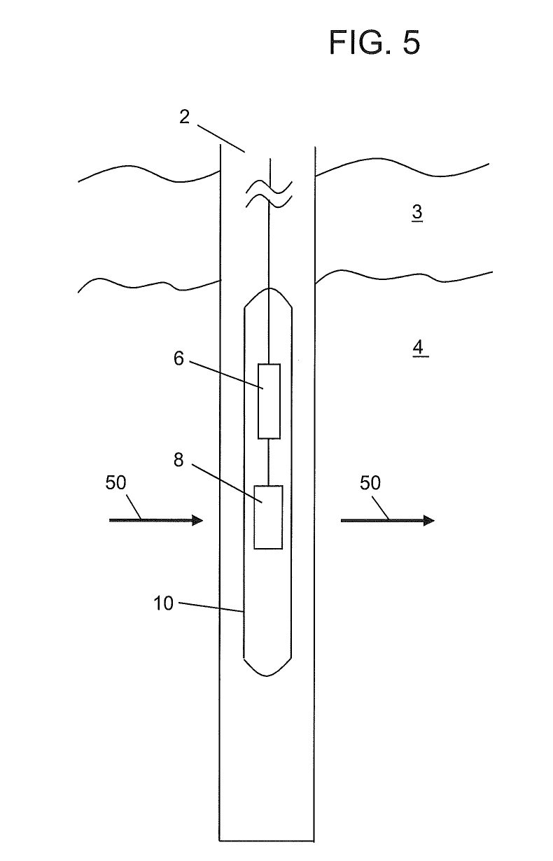

The atomic magnetometer 8 can also be used to perform other logging functions such as navigation and telemetry. FIG. 5 depicts aspects of using the atomic magnetometer 8 for navigation. Referring to FIG. 5, the atomic magnetometer 8 is shown disposed in the logging tool 10. In the embodiment of FIG. 5, the atomic magnetometer 8 is not shielded from the earth's magnetic field 50 and provides a vector measurement of the earth's magnetic field. From the vector measurement, an orientation of the logging tool 10 with respect to the earth's magnetic field can be determined.

In general, the atomic magnetometer 8 provides a scalar measurement or the total magnitude of a magnetic field. However, a technique can be used to convert a scalar atomic magnetometer 8 into a vector atomic magnetometer 8 (i.e., an atomic magnetometer that measures directional components of the magnetic field). The technique is based on a phenomenon that if a small biasing field is applied to the atomic magnetometer 8 in a certain direction while the main magnetic field to be measured is also applied, then the change in the overall magnetic field magnitude is linear in the projection of the bias magnetic field on the main magnetic field. In addition, the change in the overall magnetic field is only quadratic, and may be assumed negligible in some instances, in the projection on the orthogonal plane. The technique, therefore, in one embodiment, applies three orthogonal bias magnetic fields consecutively and performs three consecutive associated measurements of the magnitude of the overall magnetic field to construct the three-dimensional magnetic field vector.

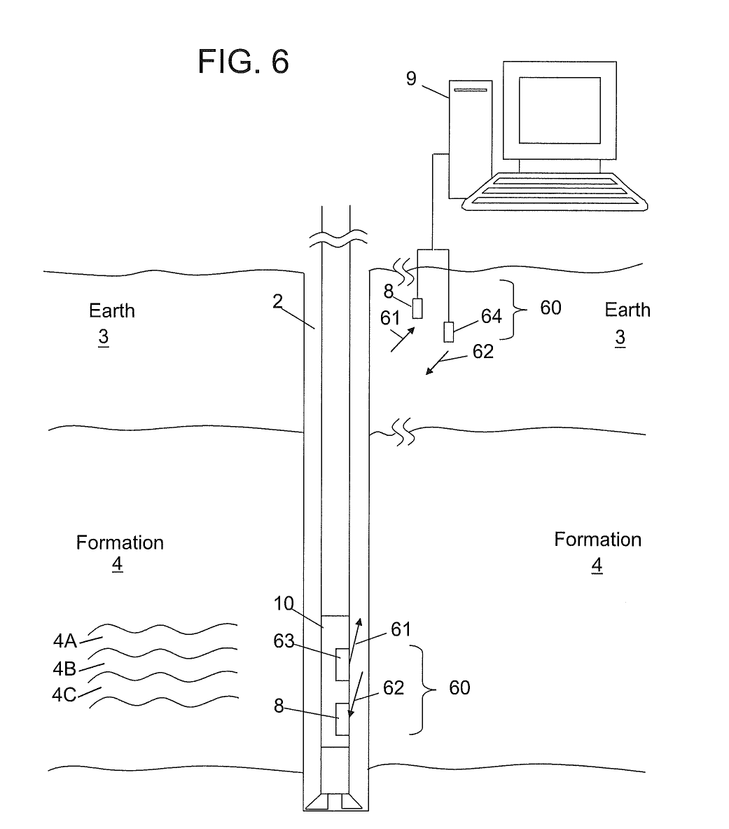

FIG. 6 depicts aspects of using the atomic magnetometer 8 for telemetry between the logging tool 10 and the processing system 9. In the embodiment of FIG. 6, the logging tool 10 is disposed at a drill string and configured for logging-while-drilling (LWD). Referring to FIG. 6, a telemetry system 60 includes one atomic magnetometer 8 disposed at or near the surface of the earth 3 for receiving a signal 61 having a magnetic component that includes data to be transmitted to the processing system 9. The telemetry system 60 can also include a second atomic magnetometer 8, which in this instance is disposed at the logging tool 10. The second atomic magnetometer 8 can receive a signal 62 having a magnetic component that includes instructions to be transmitted from the processing system 9 to the logging tool 10. The telemetry system 60 of FIG. 6 also includes transmitters 63 and 64 configured to transmit signals 61 and 62, respectively. One advantage of the telemetry system 60 is that the atomic magnetometer 8 is very sensitive to the magnetic component of electromagnetic waves as opposed to a receiver in a conventional electromagnetic telemetry system, which can have difficulty receiving an electromagnetic signal from a logging tool disposed in a borehole.

FIG. 7 presents one example of a method 70 for estimating a property of the formation 4 using the atomic magnetometer 8. The method 70 calls for (step 71) conveying the instrument 6 and the atomic magnetometer 8 using a carrier such as the logging tool 10. Thus, the instrument 6 and the atomic magnetometer 8 may be conveyed in the borehole 2 penetrating the earth formation 4 or conveyed over the surface of the earth 3. The carrier can also be another type of carrier such as the aircraft 30. Further, the method 70 calls for (step 72) measuring a strength of a magnetic field with the atomic magnetometer 8 wherein the strength of the magnetic field is related to the property.

In support of the teachings herein, various analysis components may be used, including a digital and/or an analog system. For example, the instrument 6 or the processing system 9 can include the digital and/or analog system. The system may have components such as a processor, storage media, memory, input, output, communications link (wired, wireless, pulsed mud, optical or other), user interfaces, software programs, signal processors (digital or analog) and other such components (such as discrete or integrated semiconductors, resistors, capacitors, inductors and others) to provide for operation and analyses of the apparatus and methods disclosed herein in any of several manners well-appreciated in the art. It is considered that these teachings may be, but need not be, implemented in conjunction with a set of computer executable instructions stored on a computer readable medium, including memory (ROMs, RAMs), optical (CD-ROMs), or magnetic (disks, hard drives), or any other type that when executed causes a computer to implement the method of the present invention. These instructions may provide for equipment operation, control, data collection and analysis and other functions deemed relevant by a system designer, owner, user or other such personnel, in addition to the functions described in this disclosure.

Further, various other components may be included and called upon for providing for aspects of the teachings herein. For example, sample tubing, sample chamber, power supply (e.g., at least one of a generator, a remote supply and a battery), vacuum supply, pressure supply, cooling component, heating component, motive force (such as a translational force, propulsional force or a rotational force), magnet, electromagnet, sensor, electrode, transmitter, receiver, transceiver, antenna, controller, optical unit, electrical unit or electromechanical unit may be included in support of the various aspects discussed herein or in support of other functions beyond this disclosure.

The term “carrier” as used herein means any vehicle, vessel, aircraft, device, device component, combination of devices, media and/or member that may be used to convey, house, support or otherwise facilitate the use of another device, device component, combination of devices, media and/or member. The logging tool 10 is one non-limiting example of a carrier. Other exemplary non-limiting carriers include drill strings of the coiled tube type, of the jointed pipe type and any combination or portion thereof. Other carrier examples include casing pipes, wirelines, wireline sondes, slickline sondes, drop shots, bottom-hole-assemblies, drill string inserts, modules, internal housings and substrate portions thereof.

Elements of the embodiments have been introduced with either the articles “a” or “an.” The articles are intended to mean that there are one or more of the elements. The terms “including” and “having” and their derivatives are intended to be inclusive such that there may be additional elements other than the elements listed. The conjunction “or” when used with a list of at least two terms is intended to mean any term or combination of terms.

It will be recognized that the various components or technologies may provide certain necessary or beneficial functionality or features. Accordingly, these functions and features as may be needed in support of the appended claims and variations thereof, are recognized as being inherently included as a part of the teachings herein and a part of the invention disclosed.

While the invention has been described with reference to exemplary embodiments, it will be understood that various changes may be made and equivalents may be substituted for elements thereof without departing from the scope of the invention. In addition, many modifications will be appreciated to adapt a particular instrument, situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. An apparatus for obtaining information from a subterranean environment, the apparatus comprising:
an atomic magnetometer configured to measure a magnetic field related to the information.

2. The apparatus of claim 1, wherein the information comprises a property of an earth formation in the subterranean environment and the apparatus further comprises:
a carrier configured to transport the atomic magnetometer; and
an instrument coupled to the atomic magnetometer, the instrument being configured to estimate the property using a magnetic field measurement performed by the atomic magnetometer.

3. The apparatus of claim 2, wherein the carrier comprises at least one selection from a group consisting of a vehicle, a vessel, an aircraft, a logging tool, a wireline, a slickline, a drillstring and coiled tubing.

4. The apparatus of claim 1, wherein the atomic magnetometer is configured to measure precession of spins of electrons in the magnetic field to measure the magnetic field.

5. The apparatus of claim 4, wherein the electrons are part of an alkali-metal vapor disposed in a cell.

6. The apparatus of claim 5, further comprising an optical pumping laser configured to spin-polarize atoms of the vapor.

7. The apparatus of claim 6, further comprising a probe laser disposed substantially orthogonal to the optical pumping laser and configured to measure the precession of spins.

8. The apparatus of claim 7, further comprising a photodetector configured to receive light from the probe laser traversing the cell wherein a magnitude of the received light relates to a magnitude of the magnetic field being measured.

9. The apparatus of claim 8, further comprising a shield surrounding at least a portion of the cell and configured to shield the vapor from an external magnetic field.

10. The apparatus of claim 1, wherein the atomic magnetometer is fabricated as a micro-electro-mechanical system (MEMS) device.

11. The apparatus of claim 1, wherein the information comprises navigational information for navigating the subterranean environment and the apparatus further comprises a carrier configured to convey the atomic magnetometer in a borehole penetrating the subterranean environment, the magnetic field being related to a position in the borehole.

12. The apparatus of claim 11, wherein the magnetic field is the Earth's magnetic field.

13. The apparatus of claim 11, further comprising a magnetic field source configured to consecutively apply a first bias magnetic field to the vapor, a second bias magnetic field orthogonal to the vapor orthogonal to the first magnetic field, and a third bias magnetic field to the vapor orthogonal to the first magnetic field and the second magnetic field to construct a three dimensional magnetic field vector measurement wherein the magnetic field vector is used to provide the navigation information.

14. The apparatus of claim 1, wherein the information is transmitted from the subterranean environment to a surface of the Earth and the apparatus further comprises a device configured to be disposed in a borehole penetrating the subterranean environment and to transmit energy comprising the information to the surface of the Earth, the magnetic field being related to the transmitted energy.

15. The apparatus of claim 14, further comprising another atomic magnetometer configured to be disposed in the borehole and to measure another magnetic field related to energy comprising other information transmitted from the surface of the Earth to the another atomic magnetometer.

16. A method for obtaining information from a subterranean environment, the method comprising:
conveying an atomic magnetometer to a location to obtain the information; and
measuring a magnetic field using the atomic magnetometer wherein the magnetic field is related to the information.

17. The method of claim 16, wherein the location is in a borehole penetrating the subterranean environment and the atomic magnetometer is conveyed by a carrier configured to be conveyed through the borehole.

18. The method of claim 17, wherein the information comprises a property of an earth formation in the subterranean environment.

19. The method of claim 17, wherein the location is at or above a surface of the Earth and the information comprises a property of the subterranean environment.

20. The method of claim 16, further comprising transmitting energy comprising the information to a surface of the Earth from a tool disposed in a borehole penetrating the subterranean environment wherein the magnetic field is related to the transmitted energy.
